(19) United States
(12) Patent Application Publication
(10) Pub. No.: US 2011/0147668 A1
(43) Pub. Date: Jun. 23, 2011

(54) CONDUCTIVE POLYMER COMPOSITION AND CONDUCTIVE FILM PREPARED USING THE SAME

(76) Inventors: Sang Hwa KIM, Gyunggi-do (KR); Young Soo Oh, Gyunggi-do (KR); Jong Young Lee, Gyunggi-do (KR); Ho Joon Park, Seoul (KR)

(21) Appl. No.: 12/705,483

(22) Filed: Feb. 12, 2010

(30) Foreign Application Priority Data
Dec. 23, 2009 (KR) 10-2009-0130153

(51) Int. Cl. H01B 1/12

(52) U.S. Cl. 252/500

(57) ABSTRACT

Disclosed herein is a conductive polymer composition, including: a conductive polymer; a liquid crystal polymer; and a polar solvent. The conductive polymer composition according to the present invention, differently from a general conductive polymer, can prevent the deterioration of conductive properties by using a minimum of binder or without using any binder at all. Therefore, the conductive polymer film prepared using the conductive polymer composition can be used in electrodes for various display devices, such as liquid crystal displays (LCDs), transparent touch panels, e-papers, organic light emitting diodes (OLEDs) and the like, because it has a low surface resistance of 10˜1000 Ω/□.

### CROSS REFERENCE TO RELATED APPLICATION

This application claims the benefit of Korean Patent Application No. 10-2009-0130153, filed Dec. 23^{rd} 2009, entitled “Conductive polymer composition and conductive film prepared from the composition”, which is hereby incorporated by reference in its entirety into this application.

### BACKGROUND OF THE INVENTION

1. Technical Field

The present invention relates to a conductive polymer composition and a conductive film prepared using the same.

2. Description of the Related Art

As various computers, electrical household appliances, and communication appliances are digitalized and rapidly highly-functionalized, it is keenly required to realize portable displays. In order to realize the portable displays, electrode materials for the portable displays must be transparent and have low resistance, must exhibit high flexibility so that the portable displays are mechanically stable, and must have a thermal expansion coefficient similar to that of a substrate not to overheat apparatuses and not to cause a short circuit or a great change in resistance even at high temperatures.

Currently, a transparent conductive oxide (TCO) electrode, such as an indium-tin oxide (ITO) electrode, an antimony-tin oxide (ATO) electrode or the like, is chiefly being used as an electrode for displays. This transparent conductive oxide (TCO) electrode is formed by sputtering, and its forming process is complicated and requires high cost. Particularly, the problems of the indium-tin oxide (ITO) electrode are as follows:

1. The ITO electrode is made of an inorganic material, and thus wide cracks may occur at the time of forming the same.

2. Indium, which is the main raw material of the ITO electrode and is a limited mineral resource, is being rapidly exhausted with the expansion of the market for flat display panels.

3. The ITO electrode is not easy to fabricate because its fabricating process is complicated and its characteristics are limited when it is applied to a film in order that it be used in a touch screen.

Owing to the above problems of the ITO electrode, research into its alternatives has been conducted in various ways. Among the alternatives, conductive polymers have lately attracted considerable attention because they are flexible and cheap. Examples of the conductive polymers may include polyaniline, polypyrrol, polythiophene, and the like. A polyethylenedioxythiophene/polystyrene sulfonate (PEDOT/PSS) complex, which is one of polythiophene derivatives, was developed by Bayer Corp. (brand name: Baytron P), and has been frequently used in antistatic films. However, the PEDOT/PSS complex has a surface resistance of about 10⁵˜10⁹Ω/□, and thus cannot suffice as an alternative to ITO. Further, it was proposed in many research papers that a solvent, such as dimethylsulfoxide (DMSO), ethylene glycol, sorbitol or the like, be added to ITO to improve the conductivity thereof. However, the addition of the solvent to the ITO is also insufficient as an alternative to ITO, and rather allows the conductivity of ITO to be further deteriorated by a binder which is inevitably used during a filming process. Other conductive polymers also have the above problems.

Korean Patent No. 06-92474 discloses a conductive polymer composition including polyethylenedioxythiophene (PEDOT), oxygen-containing organic compounds (excluding nitrogen-containing organic compounds), and the like. However, an adhesive polymer used to form a conductive layer is not disclosed and proposed in the Patent No. 06-92474.

Further, a transparent conductive film formed of the conductive polymer composition disclosed in Patent No. 06-92474 has a surface resistance of 10000Ω/□ or less, but this conductive polymer composition also does not suffice as an alternative to ITO.

Therefore, it is required to develop a conductive polymer having low surface resistance, which is suitable for use in an electrode for displays.

### SUMMARY OF THE INVENTION

Accordingly, the present invention has been made to solve the above-mentioned problems, and the present invention provides a transparent conductive polymer composition having low surface resistance and a conductive film prepared using the same.

An aspect of the present invention provides a conductive polymer composition, including: a conductive polymer; a liquid crystal polymer; and a polar solvent.

In the conductive polymer composition, the liquid crystal polymer may be an acrylic polymer.

Further, the liquid crystal polymer may be added in a range of 0.1 to 20 parts by weight based on the conductive polymer.

Further, the conductive polymer may be poly-3,4-ethyleneklioxythiophene/polystyrene sulfonate (PEDOT/PSS).

Further, the conductive polymer composition may have a surface resistance of 10˜1000Ω/□.

Further, the liquid crystal polymer may be 1,4-bis[3-(acryloxyoxy)propyloxy]-2-methyl benzene.

Further, the polar solvent may be any one selected from among aliphatic alcohols, aliphatic ketones, aliphatic carboxylic acid esters, aliphatic carboxylic acid amides, aromatic hydrocarbons, aliphatic hydrocarbons, acetonitrile, aliphatic sulfoxides, water, and mixtures thereof.

The conductive polymer composition may further include a secondary dopant.

The secondary dopant may be at least one polar solvent selected from the group consisting of dimethylsulfoxide, N-methylpyrrolidone, N,N-dimethylformamide, and N-dimethylacetimide.

The conductive polymer composition may further include a dispersion stabilizer.

The dispersion stabilizer may be ethylene glycol or sorbitol.

Another aspect of the present invention provides a transparent film for displays, formed of the conductive polymer composition.

### DESCRIPTION OF THE PREFERRED EMBODIMENTS

The objects, features and advantages of the present invention will be more clearly understood from the following detailed description and preferred embodiments.

Further, in the description of the present invention, when it is determined that the detailed description of the related art would obscure the gist of the present invention, the description thereof will be omitted.

Hereinafter, preferred embodiments of the present invention will be described in detail with reference to the attached drawings.

The present invention provides a conductive polymer composition which serves as a binder and has improved conductivity properties. The present invention is characterized in that the conductive polymer composition includes a liquid crystal polymer.

Therefore, the conductive polymer composition includes a conductive polymer, a liquid crystal polymer and a polar solvent.

The liquid crystal polymer is a compound exhibiting both liquid crystallinity and polymeric properties. A liquid crystal phase, which is an intermediate phase between a solid phase and a liquid phase, differently from the solid phase, has an orientational order although it does not have a positional order, so that it exhibits intrinsic properties. Further, the liquid crystal phase is different from the liquid phase which has neither positional order nor orientational order.

As described above, since the liquid crystal polymer has an orientational order as an intrinsic property, the liquid crystal polymer influences the form and arrangement of the conductive polymer when it is mixed with the conductive polymer composition after which such conductive polymer composition is applied. Therefore, due to the high order of the liquid crystal polymer, the order of the conductive polymer is also increased, and simultaneously the conductivity of a film prepared using this conductive polymer composition can be rapidly increased.

Generally, a polar solvent, referred to as a secondary dopant, is used to improve the conductivity of the conductive polymer, but, even in this case, the conductivity of the conductive polymer can be improved only to such a degree that the surface resistance of the conductive polymer reaches 1000Ω/□. Further, a binder is inevitably used to impart film characteristics to the conductive polymer, but unavoidably deteriorates the surface resistance characteristics of the conductive polymer.

However, as in the present invention, when the liquid crystal polymer is added, the binder may not be used or can be used at minimum, thus preventing the deterioration of the conductivity properties of the conductive polymer.

The liquid crystal polymer can be used in a polymer or monomer form. The liquid crystal monomer that is used may be an acrylic monomer. For example, 1,4-bis[3-(acryloxyoxy)propyloxy]-2-methyl benzene (RM257, manufactured by Merck Corp.) or RM82, manufactured by Merck Corp., may be used as the liquid crystal monomer. Further, the liquid crystal monomer may be used independently or may be used after mixing it with an isotropic monomer, such as 1,6-hexanediol diacrylate (HDDA), but the present invention is not limited thereto.

The conductive polymer that is used may be poly-3,4-ethylenedioxythiophene/polystyrene sulfonate (PEDOT/PSS), but is not limited thereto.

The liquid crystal polymer may be included in an amount of 0.1 to 20 parts by weight, preferably 5 to 10 parts by weight, based on the conductive polymer. When the amount of the liquid crystal polymer is less than 0.1 parts by weight, the effects of improving the conductivity and adhesivity attributable to the use of the liquid crystal polymer are slight. In contrast, when the amount thereof is more than 20 parts by weight, the amount of the conductive polymer and the amount of the polar solvent are not relatively sufficient, thus deteriorating conductive properties.

The conductive polymer composition of the present invention may be used after directly adding the liquid crystal polymer thereto, and may be used after it has been applied to a plastic substrate.

The conductive polymer film prepared using the conductive polymer composition of the present invention may have a surface resistance of 10˜1000 Ω/□.

Examples of the binder used in the conductive polymer film may include an acrylic binder, an epoxy binder, a urethane binder, an ether binder, a carboxylic binder, an amide binder and the like, and may be easily selected according to the kind of substrate that is used.

The polar solvent, which is a solvent used as a dispersant of the conductive polymer composition of the present invention, may be any one selected from among aliphatic alcohols, such as methanol, ethanol, i-propanol, butanol and the like; aliphatic ketones, such as acetone, methylethyl ketone and the like; aliphatic carboxylic acid esters; aliphatic carboxylic acid amides; aromatic hydrocarbons; aliphatic hydrocarbons; acetonitrile, aliphatic sulfoxides; water; and mixtures thereof.

Further, the conductive polymer composition of the present invention may further include a secondary dopant as a polar solvent in order to improve conductivity.

The secondary dopant is one or more selected from the group consisting of dimethylsulfoxide, N-methylpyrrolidone, N,N-dimethylformamide, and N-dimethylacetimide.

Further, the conductive polymer composition of the present invention may further include a dispersion stabilizer. Ethylene glycol, sorbitol or the like may be used as the dispersion stabilizer.

Furthermore, the conductive polymer composition of the present invention may further include a binder, a surfactant, an anti-foamer or the like.

The present invention provides a transparent film for a display, formed of the conductive polymer composition.

A transparent substrate, onto which the conductive polymer composition of the present invention is applied, may be made of any one selected from among glass, reinforced glass, polyethylene terephthalate (PET), polyethylenenaphthalene dicarboxylate (PEN), polycarbonate (PC), polymethylmethacrylate (PMMA), ring-shaped olefin polymers (COC), and blends thereof.

Further, the transparent substrate may have a thickness of 10˜1500 μm. When the thickness of the transparent substrate is excessively thin, the transparent substrate cannot serve as a support. In contrast, when the thickness thereof is excessively thick, the thickness of a touch screen becomes too thick.

The conductive polymer composition may be applied on the transparent substrate by spin coating, bar coating, spray coating, ink-jet printing, spreading, dipping or the like.

Further, the adhesivity of the conductive polymer composition can be improved by irradiating the transparent substrate with UV (ultraviolet), corona-treating the transparent substrate, or primer-treating the transparent substrate.

### Examples 1 to 5

The contents of components constituting a conductive polymer composition are given in Table 1 below. Here, the contents of the components are indicated by parts by weight based on the conductive polymer, that is, an aqueous PEDOT/PSS solution.

Additives were mixed with an aqueous PEDOT/PSS solution as a conductive polymer, and then stirred for about 1 hour to prepare a conductive polymer composition. The prepared conductive polymer composition was applied onto a transparent substrate, and then dried at a temperature of 80˜100 for 5 minutes to form a conductive polymer thin film. The formed conductive polymer thin film had a thickness of 100˜200 nm and exhibited a transmissivity of 80% or more.

TABLE 1

| | Aqueous | | | | Liquid |
|---|---|---|---|---|---|
| | PEDOT | | | | crystal |
| | solution | Solvent | Dopant | Binder | polymer |
| Example 1 | 28 | i-propanol 64 | DMSO 1 | acryl 5 | 2 |
| Example 2 | 28 | i-propanol 64 | DMSO 1 | PVA 5 | 2 |
| Example 3 | 28 | i-propanol 64 | DMSO 1 | — | 7 |
| Example 4 | 28 | ethanol 64 | DMSO 1 | acryl 5 | 2 |
| Example 5 | 28 | ethanol 64 | DMSO 1 | acryl 5 | 2 |

### Comparative Examples 1 and 2

Conductive polymer films were obtained using the same method as in Examples 1 to 5, except that the conductive polymer compositions given in Table 2 below were used.

In Comparative Example 1, the conductive polymer composition, differently from the conductive polymer composition of the present invention, does not include a liquid crystal polymer. In Comparative Example 2, the conductive polymer composition includes 25 parts by weight of a liquid crystal polymer, which deviates from the preferred range of adding the liquid crystal polymer of the present invention which is 0.1˜20 parts by weight

TABLE 2

| | Aqueous | | | | Liquid |
|---|---|---|---|---|---|
| | PEDOT | | | | crystal |
| | solution | Solvent | Dopant | Binder | polymer |
| Comp. | 28 | i-propanol 64 | DMSO 1 | acryl 5 | — |
| Exp. 1 | | | | | |
| Comp. | 28 | i-propanol 42 | DMSO 1 | acryl 5 | 25 |
| Exp. 2 | | | | | |

The surface resistance values of the conductive polymer films according to Examples 1 to 5 and Comparative Examples 1 and 2 are given in Table 3 below.

TABLE 3

| | Surface resistance (Ω/□) | Adhesivity |
|---|---|---|
| Example 1 | 70 | good |
| Example 2 | 100 | good |
| Example 3 | 10 | good |
| Example 4 | 500 | good |
| Example 5 | 150 | good |
| Comp. Exp. 1 | 10,000 | good |
| Comp. Exp. 2 | 2,000 | good |

As given in Table 3, it can be seen that all of the conductive polymer films formed using the conductive polymer composition have a low surface resistance of 10˜1000 Ω/□.

However, as in Comparative Example 1, when the liquid crystal polymer was not added, it can be seen that the conductive polymer film formed using the conductive polymer composition has a surface resistance of 10000Ω/□. Therefore, the conductive polymer composition according to Comparative Example 1 is not suitable as an alternative to ITO.

Further, as in Comparative Example 2, when the liquid crystal polymer was excessively added in an amount of more than 20 parts by weight, it can be seen that the conductive polymer film formed using the conductive polymer composition has a surface resistance of 2000Ω/□. Further, it can be seen that the conductive polymer composition according to Comparative Example 2 has a relatively high surface resistance compared to the conductive polymer composition according to the present invention. Therefore, it can be seen that the conductive polymer composition according to the present invention is more suitable to be used in electrodes for displays as an alternative of ITO.

As described above, the conductive polymer composition according to the present invention, differently from typical conductive polymers, can prevent the deterioration of conductive properties by using a minimum of binder or without using any binder at all.

Further, the conductive polymer film prepared using the conductive polymer composition according to the present invention can be used in electrodes for various display devices, such as liquid crystal displays (LCDs), transparent touch panels, c-papers, organic light emitting diodes (OLEDs) and the like, because it has a low surface resistance of 10˜1000 Ω/□.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications, additions and substitutions of the present invention belong to the scope of the present invention, and the specific scope of the present invention will be clearly defined by the appended claims.

What is claimed is:

1. A conductive polymer composition, comprising:
a conductive polymer;
a liquid crystal polymer; and
a polar solvent.

2. The conductive polymer composition according to claim 1, wherein the liquid crystal polymer is an acrylic polymer.

3. The conductive polymer composition according to claim 1, wherein the liquid crystal polymer is included in an amount of 0.1 to 20 parts by weight based on the conductive polymer.

4. The conductive polymer composition according to claim 1, wherein the conductive polymer is poly-3,4-ethylenedioxythiophene/polystyrene sulfonate (PEDOT/PSS).

5. The conductive polymer composition according to claim 1, wherein the conductive polymer composition has a surface resistance of 10˜1000 Ω/□.

6. The conductive polymer composition according to claim 1, wherein the liquid crystal polymer is 1,4-bis[3-(acryloxyoxy)propyloxy]-2-methyl benzene.

7. The conductive polymer composition according to claim 1, wherein the polar solvent is any one selected from among aliphatic alcohols, aliphatic ketones, aliphatic carboxylic acid esters, aliphatic carboxylic acid amides, aromatic hydrocarbons, aliphatic hydrocarbons, acetonitrile, aliphatic sulfoxides, water, and mixtures thereof.

8. The conductive polymer composition according to claim 1, further comprising a secondary dopant.

9. The conductive polymer composition according to claim 8, wherein the secondary dopant is at least one polar solvent selected from the group consisting of dimethylsulfoxide, N-methylpyrrolidone, N,N-dimethylformamide, and N-dimethylacetimide.

10. The conductive polymer composition according to claim 1, further comprising a dispersion stabilizer.

11. The conductive polymer composition according to claim 10, wherein the dispersion stabilizer is ethylene glycol or sorbitol.

12. A transparent film for displays, formed of the conductive polymer composition of claim 1.
